(19) United States
(12) Patent Application Publication
(10) Pub. No.: US 2016/0141810 A1
(43) Pub. Date: May 19, 2016

(54) AUTOMATIC DETECTION OF A POWER STATUS OF AN ELECTRONIC DEVICE AND CONTROL SCHEMES BASED THEREON

(71) Applicant: Branch Media Labs, Inc., Santa Clara, CA (US)

(72) Inventors: Pankaj Kumar Kashyap, Pune (IN); Sharath Hariharpur Satheesh, Bangalore (IN); Vinod Gopinath, Bangalore (IN); Ashish Aggarwal, Stevenson Ranch, CA (US)

(21) Appl. No.: 14/945,201

(22) Filed: Nov. 18, 2015

Related U.S. Application Data
(60) Provisional application No. 62/081,397, filed on Nov. 18, 2014.

(51) Int. Cl. H01R 13/66; H01R 24/76

(52) U.S. Cl. CPC H01R 13/6683; H01R 24/76

(57) ABSTRACT

Embodiments described herein automatically detect a power state of an electronic device and perform a control scheme based thereon. For example, a control device determines that an electronic device is to be in a desired power state. A socket device coupled to the electronic device determines an amount of current or power being provided to the electronic device and transmits an indication of the amount of current or power or a determined power state to the control device. Based on the indication, the control device determines the current power state of the electronic device. If the control device determines that the current power state is not the desired power state, the control device transmits a signal to the electronic device, which causes it to transition to the desired power state.

### CROSS-REFERENCE TO RELATED APPLICATIONS

This application claims priority to U.S. Provisional Patent Application No. 62/081,397, filed Nov. 18, 2014, the entirety of which is incorporated by reference herein.

This application is also related to the following U.S. Patent Application, which is incorporated by reference herein:

U.S. patent application Ser. No. ______ (Attorney Docket No. H16.00010001), filed on even date herewith and entitled “Seamless Setup and Control for Home Entertainment Devices and Content,” which claims priority to U.S. Provisional Application No. 62/081,430, filed Nov. 18, 2014, the entirety of which is incorporated by reference.

### BACKGROUND

1. Technical Field

The present invention relates to methods, systems, and apparatuses for automatic detection of a power status of electronic devices, and for control schemes based on such automatic detection.

2. Background Art

Consumer electronic devices in a typical home are interconnected and, in some cases, centrally controlled. Such a setup is categorized under home automation. A typical home audio-video entertainment setup consists of various audio/video (AV) source devices (e.g., a digital versatile disc (DVD) player, a set-top box (STB), etc.), an AV repeater/receiver (AVR) (e.g., to play out audio on external speakers), and a display device (e.g., a television (TV) or high-definition TV (HDTV)). When a user wants to consume certain content (e.g., listen to music, watch a movie, etc.), the user is typically required to power on more than one device (e.g., an AVR, an AV source device, and/or a TV). This often requires the user to power on each of these devices with a different remote control, which can be laborious and annoying to the user.

### BRIEF SUMMARY

Methods, systems, and apparatuses are described for automatic detection of a power status of electronic devices and control schemes based on such automatic detection, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 is a block diagram of a system that is configured to determine a power state of an electronic device and perform an automated control scheme based on the determined power state in accordance with an embodiment.

FIG. 2A is a front view of a socket device in accordance with an embodiment.

FIG. 2B is a rear view of the socket device shown in FIG. 2A.

FIG. 3 is a block diagram of a system comprising a socket device configured to measure an amount of current provided to an electronic device and a control device configured to perform an automated control scheme based on the measured amount of current in accordance with an embodiment.

FIG. 4 shows a graph that illustrates an amount of current provided to and/or consumed by an electronic device as it transitions between different power states in accordance with an embodiment.

FIG. 5 is a block diagram of a system that is configured to determine a power state of one or more electronic devices and perform an automated control scheme based on the determined power state(s) in accordance with an embodiment.

FIG. 6 is a block diagram of a system that includes an electronic device integrated with a socket device in accordance with an embodiment.

FIG. 7 is a block diagram of a system that is configured to determine a power state of one or more electronic devices and perform an automated control scheme based on the determined power state(s) in accordance with another embodiment.

FIG. 8 depicts a flowchart of a method for performing an automated control function by a control device in accordance with an embodiment.

FIG. 9 is a block diagram of control device in accordance with an embodiment.

FIG. 10 is a block diagram of a system that is configured to determine a power state of an electronic device and perform an automated control scheme based on the determined power state(s) in accordance with another embodiment.

FIG. 11 is a block diagram of a system that is configured to determine a power state of one or more electronic devices and perform an automated control scheme based on the determined power state(s) in accordance with another embodiment.

FIG. 12 depicts a flowchart of a method for determining a power state of an electronic device by a control device in accordance with an embodiment.

FIG. 13 is a block diagram of a socket device in accordance with an embodiment.

FIG. 14 is a block diagram of a computer system in accordance with an embodiment.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” “front,” “rear,” etc.) used herein are for purposes of illustration only, and that practical implementations of the structures described herein can be spatially arranged in any orientation or manner.

Numerous exemplary embodiments are described as follows. It is noted that the section/subsection headings used herein are not intended to be limiting. Embodiments described in this document may be eligible for inclusion within multiple different sections or subsections. Furthermore, disclosed embodiments may be combined with each other in any manner.

A socket device is described herein. The socket device includes a first receptacle, a second receptacle, a sensing component and a transmit component. The first receptacle is configured to receive a first prong of an electrical plug and couple the first prong to a first conductive element of the socket device. The second receptacle is configured to receive a second prong of the electrical plug and couple the second prong to a second conductive element of the socket device. The sensing component is configured to determine an amount of current provided via at least one of the first conductive element and the second conductive element. The transmit component is configured to transmit an indication of the amount of current to a control device.

A system is also described herein. The system includes a socket device and a control device. The socket device is configured to determine an amount of current being provided to a first electronic device attached thereto and transmit an indication of the amount of current. The control device is configured to receive the indication of the amount of current from the socket device, determine that the first electronic device is to be in a first power state, determine whether the first electronic device is in one of the first power state or a second power state based on the indication, and, in response to a determination that the first electronic device is in the second power state, transmit a signal to the first electronic device that causes the first electronic device to transition to the first power state.

A method for controlling a first electronic device is also described herein. In accordance with the method, an indication of an amount of current being provided to the first electronic device is received from a socket device attached to the first electronic device. A determination is made that the first electronic device is to be in a first power state. A determination is made whether the first electronic device is in one of the first power state or a second power state based on the indication. In response to a determination that the first electronic device is in the second power state, a control signal is transmitted to the first electronic device that causes the first electronic device to transition to the first power state.

Another socket device is described herein. The socket device comprises a sensing component, a processing component and a transmit component. The sensing component is configured to determine an amount of power being provided to the socket device from a first electronic device attached to the socket device. The processing component is configured to determine a power state of the electronic device based on the determined amount of power. The transmit component is configured to provide an indication indicating the determined power state to a control device.

### Example Embodiments

Subsection A describes embodiments that are used to determine a power state of an electronic device based on an amount of current being provided to the electronic device and to perform an automated control scheme based the determined power state. Subsection B describes embodiments that are used to determine a power state of an electronic device based on an amount of power being provided to a socket device by the electronic device and to perform an automated control scheme based the determined power state.
A. Systems and Methods for Determining a Power State of an Electronic Device Based on an Amount of Current Being Provided to the Electronic Device and Performing an Automated Control Scheme Based on the Determined Power State
   a. An External Socket Device Configured to Measure an Amount of Current Provided to an Electronic Device Coupled Thereto

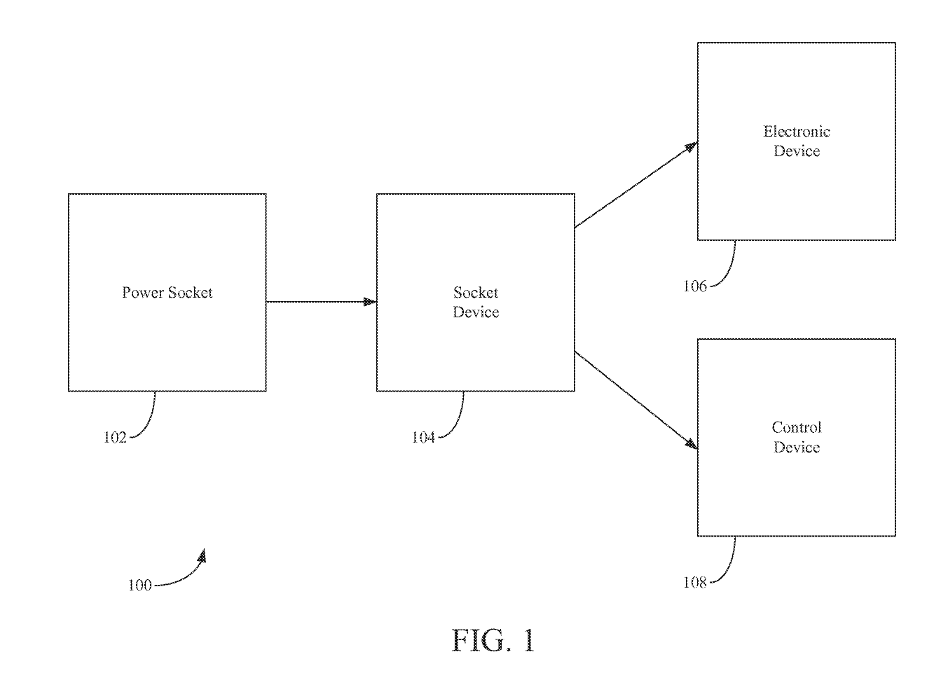

FIG. 1 is a block diagram of a system 100 that is configured to determine a power state of an electronic device 106 and perform an automated control scheme based on the determined power state in accordance with an embodiment. As shown in FIG. 1, system 100 includes a power socket 102, a socket device 104, electronic device 106 and a control device 108. Power socket 102 is configured to provide power (e.g., alternating current (AC) power) to an electronic device coupled thereto (e.g., electronic device 106). Power socket 102 may be integrated or fixed on equipment (e.g., an extension cable, a power strip, a table, a desk, etc.) or a building structure (e.g., an interior wall, an exterior wall, cabinetry, etc.) of a building. Power socket 102 comprises one or more receptacles that are each adapted to receive a prong of another apparatus (e.g., an electrical plug of a power cord or socket device 104 as described below). Power socket 102 is configured to provide power to the other apparatus upon insertion of the prong(s) of that apparatus into the receptacle(s) of power socket 102 (i.e., plugging the prong(s) of the apparatus into the receptacle(s) of power socket 102).

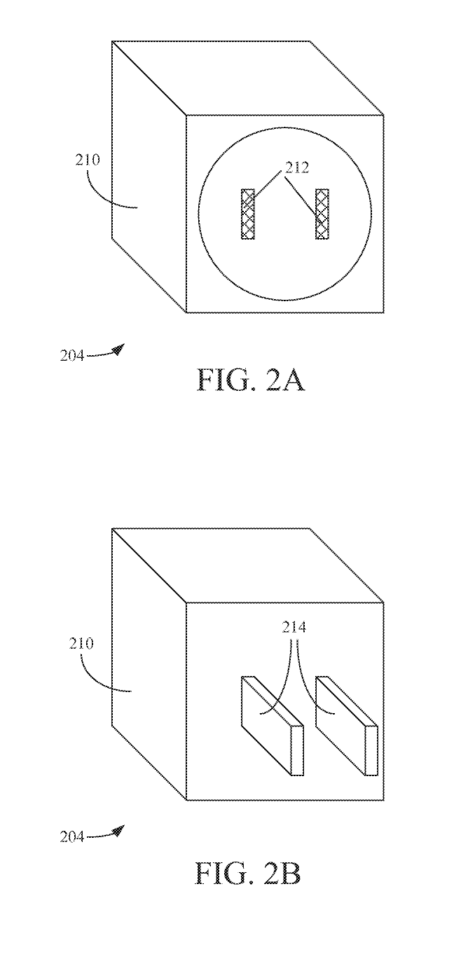

In accordance with an embodiment, socket device 104 is configured to be coupled to (e.g., plugged into) power socket 102. For example, as described below with reference to FIGS. 2A and 2B, socket device 104 may comprise prong(s) that are configured to be inserted into receptacles of power socket 102. Socket device 104 is further configured to be coupled to a power cord that is coupled to electronic device 106. For example, an electronic power plug of a power cord that is coupled to electronic device 106 may be configured to be plugged into power socket 104. In this way, power may be provided from power socket 102 to electronic device 106 via socket device 104 and the power cord. That is, power from power socket 102 is passed through socket device 104 and the power cord and provided to electronic device 106.

In accordance with another embodiment, socket device 104 is configured to be plugged into electronic device 106. For example, socket device 104 may comprise receptacle(s) that are configured to receive prong(s) included on electronic device 106, which are normally used to couple a power cord of electronic device 106 thereto. In accordance with such an embodiment, socket device 104 is further configured to comprise prong(s) that are configured to be coupled to the power cord. For example, the power cord may comprise receptacle(s) that are configured to receive the prong(s) included in electronic device 106. However, instead of coupling the power cord to the prong(s) of electronic device 106, the power cord is coupled to the prong(s) of socket device 104.

Socket device 104 is further configured to determine (e.g., measure) an amount of current provided to electronic device 106 and transmit an indication of the measured amount of current to control device 108. In accordance with an embodiment, socket device 104 is configured to provide the indication via a wired connection (e.g., via a Universal Serial Bus (USB) cable, a coaxial cable, etc.). In accordance with another embodiment, socket device 104 is configured to provide the indication via a wireless connection (e.g., via infrared (IR) communication, radio frequency (RF) communication (e.g., Bluetooth™, as described in the various standards developed and licensed by the Bluetooth™ Special Interest Group, technologies such as ZigBee® that are based on the IEEE 802.15.4 standard for wireless personal area networks, near field communication (NFC), other RF-based communication technologies such as any of the well-known IEEE 802.11 protocols, etc.) and/or the like.

Control device 108 may be configured to determine that electronic device 106 is to be in a desired power state and to cause electronic device 106 to transition to that desired power state. This determination may be determined based on detecting a triggering event. For example, the triggering event may be determining that a user has performed an action intended to cause electronic device 106 to transition to the desired power state. An example of an action intended to cause electronic device 106 to transition to a desired power state includes, but is not limited to, initiating a command via a remote control device and/or control device 108 (or an application executing thereon, e.g., a home automation application) that is intended to cause one or more electronic devices (e.g., electronic device 106) to transition to a desired power state. In another example, the triggering event may be determining that another electronic device has transitioned to a particular power state.

Once control device 108 determines that electronic device 106 is to be in a desired power state, control device 108 may determine whether electronic device 106 is already in the desired power state to prevent accidentally causing electronic device 106 to transition to the wrong power state. To determine whether or not electronic device 106 is already in that desired power state, control device 108 may determine the power state of electronic device 106 based on the indication of the amount of current provided to electronic device 106 received from socket device 104. If the determined power state is not the desired power state, control device 108 causes electronic device 106 to transition to the desired power state. If the determined power state is the desired power state, no further action is required by control device 108.

Example power states include, but are not limited to, a power-off state, a low-power (or standby or sleep) state, and a power-on state. In a power-off state, electronic device 104 is deactivated (i.e. turned off). In an embodiment, no current is provided to and/or consumed by electronic device 106 in the power-off state. In a power-on state, electronic device 106 is fully functional. In a standby state, electronic device 106 is in a power-savings mode where certain components and/or features of electronic device 106 are disabled (switched off) until needed. The amount of current provided to and/or consumed by electronic device 106 in this mode may be more than in the power-off state, but less than the power-on state.

Examples of electronic device 106 may include, but are not limited to, a TV, an AVR, a DVD player, a compact disc (CD) player, a Blu-ray player, an STB (e.g., a cable TV set-top box, a satellite TV set-top box, etc.), a computer, a video game console, a media streaming device, a home appliance (e.g., a mixer, a grinder, a washing machine, a dryer, a microwave oven, a stove, a fan, a lamp, an air conditioner, etc.), and/or the like.

It is noted that control device 108 may be implemented as a stand-alone device (as shown in FIG. 1), such as a set-top box, a laptop, a tablet, a telephone (e.g., a smart phone and/or a mobile phone, or a switching device or a remote control device (as disclosed in U.S. patent application Ser. No. ______ (Atty. Docket No. H16.00010001), entitled, “Seamless Setup and Control for Home Entertainment Devices and Content,” the entirety of which is incorporated by reference herein), or may be integrated in another electronic device.

FIGS. 2A and 2B depict a socket device 204 in accordance with an embodiment. FIG. 2A depicts a front view of socket device 204, and FIG. 2B depicts a rear view of socket device 204. Socket device 204 may be just one example of socket device 104, as shown in FIG. 1. As shown in FIG. 2A, socket device 204 comprises a housing 210 that includes receptacles 212. Each of receptacles 212 is adapted to receive a corresponding prong of an electrical plug of a power cord that is coupled to an electronic device (e.g., electronic device 106, as shown in FIG. 1). It is noted that while receptacles 212 are shown as being rectangular, receptacles 212 may be of any shape, including, but not limited to, circular, square, etc. It is further noted that while two receptacles 212 are shown, socket device 204 may comprise any number of receptacles 212.

As shown in FIG. 2B, housing 210 also includes prongs 214. Each of prongs 214 is adapted to be inserted into a corresponding receptacle of a power socket (e.g., power socket 102, as shown in FIG. 1). It is noted that while prongs 214 are shown as being rectangular, prongs 214 may be of any shape, including, but not limited to, circular, square, etc. It is further noted that while two prongs 214 are shown, socket device 204 may comprise any number of prong(s) 214.

Housing 210 further comprises at least a first conductive element (e.g., a wire, a trace, etc.) and a second conductive element (both not shown). The first conductive element is configured to provide power to an electronic device (e.g., electronic device 106, as shown in FIG. 1) when coupled to a corresponding prong of an electrical plug of a power cord that is coupled to the electronic device and a corresponding receptacle of a power socket (e.g., power socket 102, as shown in FIG. 1). The first conductive element may be referred to as a live conductive element (e.g., a live wire). The second conductive element is configured to return power back to the power socket when coupled to a corresponding prong of the electrical plug of the power cord and a corresponding receptacle of the power socket. The second conductive element may be referred to as a neutral conductive element (e.g., a neutral wire).

When socket device 204 is attached to a power socket (i.e., prongs 214 are plugged into the receptacles of the power socket) and an electrical plug of a power cord that is coupled to an electronic device is attached to socket device 204 (i.e., prongs of the electrical plug are plugged into receptacles 212 of socket device 204), power provided by the power socket is passed through socket device 204 and the power cord and provided to and/or from the electrical device via the first conductive element and the second conductive element.

It is noted that while housing 210 is shown in FIGS. 2A and 2B as being cuboid-shaped, housing 210 may be of any shape, including, but not limited to, circular, rectangular, etc. It is further noted that the representation of socket device 204 is exemplary in nature with respect to organization, composition, location of features, etc., and that other representations are contemplated.

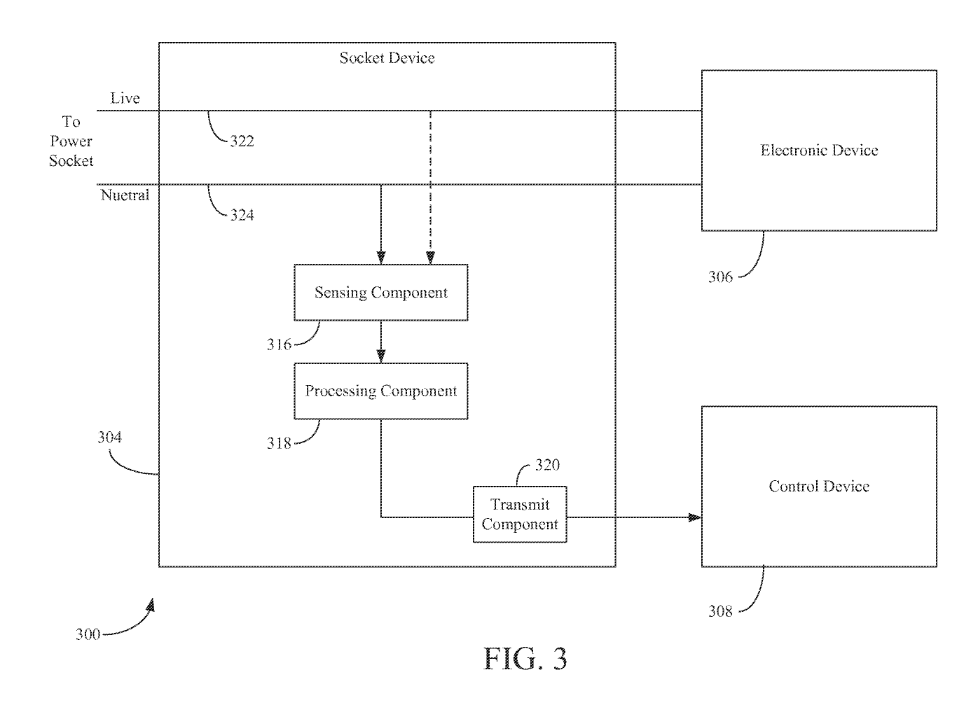

FIG. 3 is a block diagram of a system 300 comprising a socket device 304 configured to measure an amount of current provided to an electronic device 306 and a control device 308 configured to perform an automated control scheme based on the measured amount of current in accordance with an embodiment. Socket device 304 may be an example of socket device 104 as described above in reference to FIG. 1 and socket device 204 as described above in reference to FIGS. 2A and 2B. Electronic device 306 may be an example of electronic device 106, as described above in reference to FIG. 1. Control device 308 may be an example of control device 108, as described above in reference to FIG. 1.

As shown in FIG. 3, socket device 304 includes a sensing component 316, a processing component 318 and a transmit component 320. As further shown in FIG. 3, socket device 304 includes a first conductive element 322 and a second conductive element 324. First conductive element 322 is configured to provide power to electronic device 306 when coupled to a corresponding prong of an electrical plug of a power cord that is coupled to electronic device 306 and a corresponding receptacle of a power socket (e.g., power socket 102, as shown in FIG. 1). First conductive element 322 may be referred to as a live conductive element. Second conductive element 324 is configured to return power back to the power socket when coupled to a corresponding prong of an electrical plug of a power cord that is coupled to electronic device 106 and a corresponding receptacle of the power socket. Second conductive element 324 may be referred to as a neutral conductive element.

Sensing component 316 may be configured to measure an amount of current being provided to electronic device 306. For example, sensing component 316 may be coupled to second conductive element 324 and may be configured to measure an amount of analog current being provided via second conductive element 324. Sensing component 316 may provide the measurement of the current to processing component 318.

In accordance with an embodiment, the amount of current is measured using a resistive element having a known resistance. For example, a shunt resistor may be coupled to second conductive element 324. Sensing component 316 may be configured to determine the voltage across the shunt resistor. In accordance with such an embodiment, sensing component 316 determines the amount of current being provided to electronic device 306 based on the determined voltage across the shunt resistor and the known resistance of the shunt resistor.

In accordance with another embodiment, sensing component 316 comprises a current transformer. The current transformer may comprise a primary winding that is coupled to second conductive element 324 and measures the amount of current provided by second conductive element 324. The current transformer may also comprise a secondary winding that produces a current which is proportional to the current being measured by the primary winding. The current produced by the secondary winding is indicative of the amount of current being provided to electronic device 306.

In accordance with yet another embodiment, sensing component 316 may comprise a Hall effect current sensor. The Hall effect current sensor may be coupled to second conductive element 324 and may be configured to measure a magnetic field generated by second conductive element 324 as current flows through second conductive element 324. The Hall effect current sensor provides an analog voltage output that is proportional to the strength of the magnetic field and current flowing through neutral conductive element 324. In accordance with such an embodiment, sensing component 324 determines a measure of the current being provided to the electronic device using the measured voltage.

It is noted that while sensing component 316 is coupled to second conductive element 324 in the above-described embodiments, in accordance with other embodiments, sensing component 316 is coupled to first conductive element 322 and may determine the amount of current being provided to the electronic device using any of the techniques described above. It is further noted that the current sensing techniques described above are purely exemplary and that other current sensing techniques may be used to measure the amount of current being provided to electronic device 106.

Processing component 318 may be configured to receive the measured current from sensing component 316. Processing component 318 may comprise an analog-to-digital converter that converts the measured current to a digital signal. The digital signal may be an indication that indicates the measured amount of current provided to electronic device 306. Processing component 318 may be further configured to provide the indication to transmit component 320.

Transmit component 320 may be configured to transmit the indication to control device 308. In accordance with an embodiment, transmit component 320 is configured to provide the indication via a wired connection (e.g., via a USB cable, a coaxial cable, etc.). In accordance with another embodiment, the indication is provided to control device 308 via a wireless connection (e.g., via IR communication, RF communication, etc.). In accordance with the latter embodiment, processing component 318 and/or transmit component 320 may be further configured to format the indication in accordance with the wireless communication scheme used to transmit the indication. In further accordance with such an embodiment, transmit component 320 may comprise an antenna that wirelessly transmits the indication to control device 308.

It is noted that in accordance with certain embodiments, one or more components of socket device 304 may be incorporated into an electrical plug or power cord of electronic device 306. For example, sensing component 316, processing component 318, and/or transmit component 320 may be incorporated into the electrical plug or power cord. In accordance with such embodiments, a separate socket device is not required. Instead, the foregoing techniques may be achieved by the electrical plug or power cord including such components.

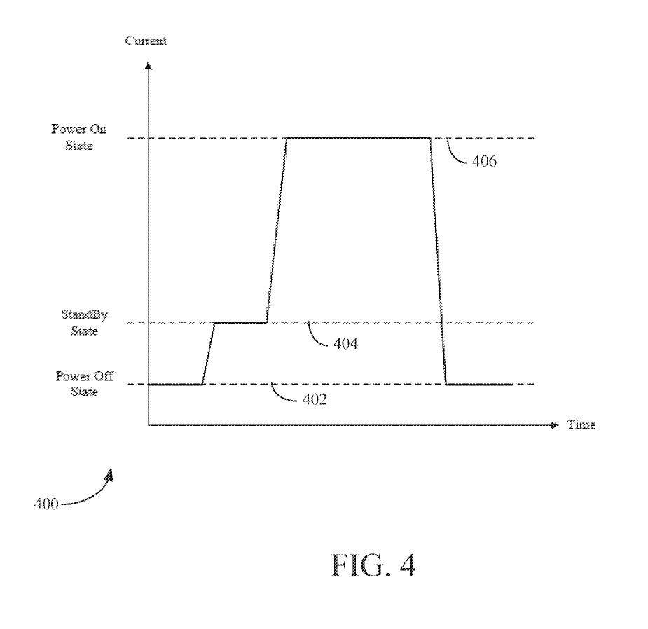

Control device 308 is configured to receive the indication from socket device 304 and determine a power state of electronic device 306 based on the indication. It is understood that the current consumed by electronic device 306 varies based on the power state of electronic device 306. For example, FIG. 4 shows a graph 400 that illustrates an amount of current provided to and/or consumed by an electronic device (e.g., electronic device 306) as it transitions between different power states in accordance with an embodiment. As shown in FIG. 4, when the electronic device is in a power-off state, the current provided to and/or consumed by the electronic device corresponds to first amperage 402. When the electronic device is in a standby state, the current provided to and/or consumed by electronic device corresponds to a second amperage 404 that is a greater than first amperage 402. When the electronic device is in a power-on state, the current provided to and/or consumed by the electronic device corresponds to a third amperage 406 that is a greater than first amperage 402 and second amperage 404.

Referring again to FIG. 3, in accordance with an embodiment, control device 308 is configured to determine the power state of electronic device 306 by comparing the measured current represented by the received indication to one or more values or thresholds that each correspond to a particular power state. For example, control device 308 may be configured to determine whether the measured current is approximately equal to (or within a predefined range of) any of first amperage 402, second amperage 404 and third amperage 406 to determine the power state of electronic device 306. As another example, control device 308 may be configured to determine whether the measured current is less than second amperage 404 (indicating the power-off state), greater than or equal to second amperage 404 and less than third amperage 406 (indicating the standby state), or greater than or equal to third amperage 406 (indicating the power-on state). Still other techniques may be used to determine the power state of electronic device 306 based on first amperage 402, second amperage 404 and third amperage 406.

It should be noted that the levels shown for the amperages/power states in graph 400 are exemplary only, and that different electronic devices may have different current draws for the different states. It is further contemplated herein that the embodiments described may be configured to utilize different levels of current based on the requirements of different electronic devices.

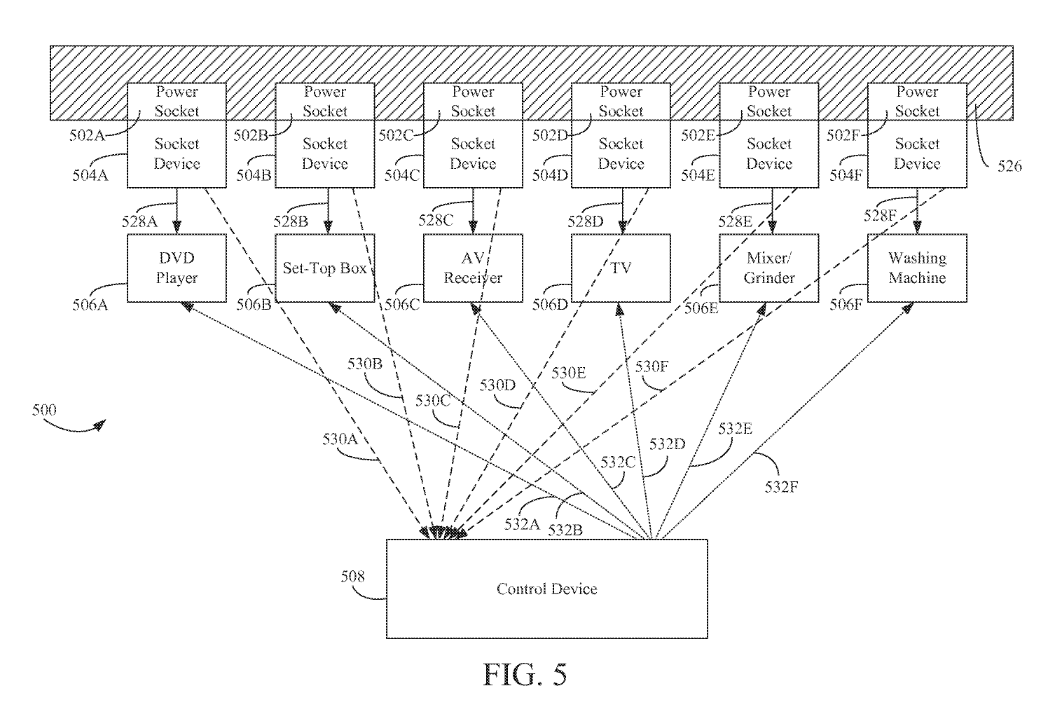

Once the power state of electronic device 306 is determined, control device 308 may be configured to perform an automated control scheme based on the determined power state(s). By way of further illustration, FIG. 5 shows a system 500 that is configured to determine a power state of any or all of electronic device(s) 506A-506F and perform an automated control operation for any or all of electronic devices 506A-506F based on the determined power state(s) in accordance with an embodiment. As shown in FIG. 5, system 500 includes power sockets 502A-502F, socket devices 504A-504F, electronic devices 506A-506F and control device 508. Each of power sockets 502A-502F are fixed and/or integrated into a wall 526 of a building structure. Each of power sockets 502A-502F may be an example of power socket 102, as described above in reference to FIG. 1. Each of socket devices 504A-504F may be an example of socket device 104, socket device 204 or socket device 304, as respectively described above in reference to FIGS. 1, 2A, 2B and 3. Socket device 504A is coupled to (e.g., plugged into) power socket 502A, socket device 504B is coupled to power socket 504B, socket device 504C is coupled to power socket 504C, socket device 504D is coupled to power socket 504D, socket device 504E is coupled to power socket 504E, and socket device 504F is coupled to power socket 504F.

Each of electronic devices 506A-506F may be an example of electronic device 106 or electronic device 306, as described above in reference to FIGS. 1 and 3, respectively. A power cord of electronic device 506A is coupled to (e.g., plugged into) socket device 504A, a power cord of electronic device 506B is coupled to socket device 504B, a power cord of electronic device 506C is coupled to socket device 504C, a power cord of electronic device 506D is coupled to socket device 504D, a power cord of electronic device 506E is coupled to socket device 504E, and a power cord of electronic device 506F is coupled to socket device 504F. As shown in FIG. 5, electronic device 506A is a DVD player, electronic device 506B is a set-top box, electronic device 506C is an AV receiver, electronic device 506D is a TV, electronic device 506E is a home appliance (i.e., a mixer or grinder), and electronic device 506F is another home appliance (i.e., a washer). The depiction of these particular electronics devices/home appliances is merely for illustrative purposes. Each of electronic device 506A-506F may be any electronic device or home appliance that is capable of receiving AC power via a power socket.

Socket device 504A provides power 528A (received from power socket 502A) to electronic device 506A. Socket device 504B provides power 528B (received from power socket 502B) to electronic device 506B. Socket device 504C provides power 528C (received from power socket 502C) to electronic device 506C. Socket device 504D provides power 528D (received from power socket 502D) to electronic device 506D. Socket device 504E provides power 528E (received from power socket 502E) to electronic device 506E. Socket device 504F provides power 528F (received from power socket 502B) to electronic device 506F.

Socket device 504A is configured to measure an amount of current provided to electronic device 506A and provide an indication 530A of the measured amount of current to control device 508. Socket device 504B is configured to measure an amount of current provided to electronic device 506B and provide an indication 530B of the measured amount of current to control device 508. Socket device 504C is configured to measure an amount of current provided to electronic device 506C and provide an indication 530C of the measured amount of current to control device 508. Socket device 504D is configured to measure an amount of current provided to electronic device 506D and provide an indication 530D of the measured amount of current to control device 508. Socket device 504E is configured to measure an amount of current provided to electronic device 506E and provide an indication 530E of the measured amount of current to control device 508. Socket device 504F is configured to measure an amount of current provided to electronic device 506F and provide an indication 530F of the measured amount of current to control device 508.

Control device 508 may be an example of control device 108 or control device 308, as described above in reference to FIGS. 1 and 3, respectively. Control device 508 may be configured to determine that any or all of electronic devices 506A-506F are to be in a desired power state and cause such electronic devices to transition to that desired power state. This determination may be determined based on detecting a triggering event. One example of a triggering event may be determining that another electronic device has transitioned to a particular power state (e.g., in response to receiving an indication from a socket device associated with that electronic device). Another example of a triggering event may be determining that a user has performed an action intended to cause any or all of electronic devices 506A-506F to transition to the desired power state. One such action may be a user interacting with a “Watch DVD” interface element (e.g., a button or selectable icon) (or the like) of a remote control device and/or control device 508 (or application executing thereon) that, when activated, is configured to activate a plurality of electronic devices (e.g., TV 506D and DVD player 506A). Control device 508 may be configured to detect that this interface element has been activated and, in response, determine the power states of TV 506D and DVD player 506A to determine whether these electronic devices are already in the desired power state.

Another such action may be a user interacting with a “System Off” interface element of a remote control device and/or control device 508 (or application executing thereon) that, when activated, is configured to power off a plurality of electronic devices (e.g., electronic devices 506A-506F) coupled to control device 508. Control device 508 may be configured to detect that this interface element has been activated and, in response, determine the power states of these electronic devices to determine whether these electronic devices are already in the desired power state.

Yet another such action may be a user interacting with a “Home Theater Mode” interface element of a remote control device and/or control device 508 (or application executing thereon) that, when activated, configures the room to be in a “home theater mode,” where the lights in the room are to be turned off or dimmed and one or more other electronic devices (e.g., TV 506D, AN Receiver 506C, DVD player 506A) are to be powered on.

It is noted that the triggering events described above are purely exemplary and that any type of triggering event may be used to determine whether any or all of electronic device 506A-506F are to be in a desired power state.

To determine whether or not an electronic device is already in a desired power state, control device 508 may determine the power state of that electronic device based on the indication of the amount of current provided to that electronic device from its associated socket device. For example, control device 508 may be configured to determine the power state of electronic device 506A based on indication 530A. Control device 508 may be configured to determine the power state of electronic device 506B based on indication 530B. Control device 508 may be configured to determine the power state of electronic device 506C based on indication 530C. Control device 508 may be configured to determine the power state of electronic device 506D based on indication 530D. Control device 508 may be configured to determine the power state of electronic device 506E based on indication 530E. Control device 508 may be configured to determine the power state of electronic device 506F based on indication 530F. Control device 508 may determine the power state of electronic devices 506A-506F based on indications 530A-530F using any of the techniques described above in reference to FIGS. 3 and 4.

If the determined power state for a particular electronic device is the desired power state, then no further action is required by control device 508 with respect to altering the power state of that particular electronic device. However, if the determined power state for a particular electronic device is not the desired power state, control device 508 causes the particular electronic device to transition to the desired power state. For example, control device 508 may transmit a control signal to at least one of electronic devices 506A-506F that causes that electronic device to transition to the desired power state (e.g., a power-on state, a power-off state, or a standby state). For instance, control device 508 may transmit a control signal 532A to electronic device 506A that causes electronic device 506A to transition to a desired power state. Control device 508 may transmit a control signal 532B to electronic device 506B that causes electronic device 506B to transition to a desired power state. Control device 508 may transmit a control signal 532C to electronic device 506C that causes electronic device 506C to transition to a desired power state. Control device 508 may transmit a control signal 532D to electronic device 506D that causes electronic device 506D to transition to a desired power state. Control device 508 may transmit a control signal 532E to electronic device 506E that causes electronic device 506E to transition to a desired power state. Control device 508 may transmit a control signal 532F to electronic device 506F that causes electronic device 506F to transition to a desired power state. In accordance with an embodiment, any of control signals 532A-532F may be transmitted via a wired connection (e.g., via a Universal Serial Bus (USB) cable, a coaxial cable, etc.). In accordance with another embodiment, any of control signals 532A-532F may be transmitted via wireless connection (e.g., via IR communication, RF communication, etc.).

Control device 508 may access a device mapping (e.g., table) that indicates which electronic device(s) should be powered on, powered off or placed into standby in response to detecting a particular triggering event. For example, the device mapping may indicate that when a first triggering event is detected, set-top box 506B, TV 506D and/or AV receiver 506C should be powered on. In another example, the device mapping may indicate that when a second triggering event is detected, TV 506D, AV Receiver 506C, set-top box 506B and/or DVD player 506A should be powered off or placed into standby mode. In yet another example, the device mapping may indicate that when a third triggering event is detected, TV 506D and/or AV receiver 506C are to be powered, and washing machine 506F and/or mixer/grinder 506E are to be powered off (e.g., so that the noise produced from these devices do not interrupt the user's entertainment experience).

The examples provided above are purely exemplary. Any mapping between triggering events and/or electronic devices 506A-506F may be defined. In accordance with an embodiment, the device mapping is stored locally to control device 508. In accordance with another embodiment, the device mapping is stored remotely from control device 508 (e.g., on a server communicatively coupled to control device 508).

In accordance with an embodiment, the device mapping may be user-defined. For example, control device 508 may be configured to cause a graphical user interface (GUI) to be rendered on a display device coupled thereto (e.g., TV 506D) or included therewith that enables the user to configure the device mapping.

It is noted that control device 508 may be implemented as a stand-alone device (as shown in FIG. 5), such as a set-top box, a laptop, a tablet, a telephone (e.g., a smart phone and/or a mobile phone, or a switching device or a remote control device (as disclosed in U.S. patent application Ser. No. ______ (Atty. Docket No. H16.00010001), entitled, “Seamless Setup and Control for Home Entertainment Devices and Content,” the entirety of which is incorporated by reference herein), or may be integrated into any of electronic devices 506A-506F.
b. A Socket Device Integrated into an Electronic Device Configured to Measure an Amount of Current Provided to another Electronic Device Coupled Thereto

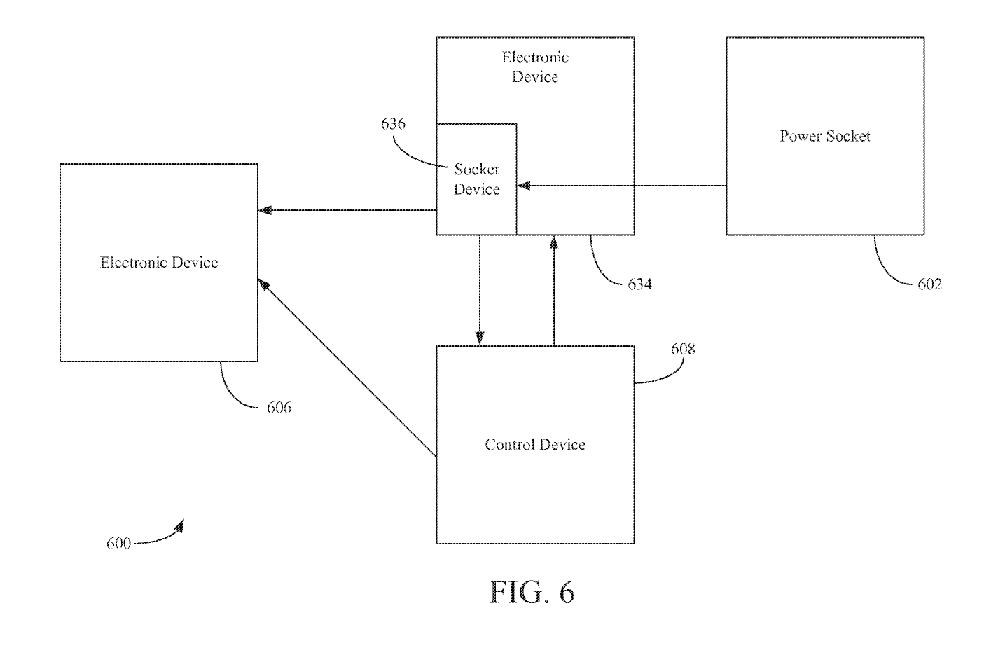

FIG. 6 is a block diagram of a system 600 that comprises an electronic device 634 integrated with a socket device 636 in accordance with an embodiment. As shown in FIG. 6, system 600 includes a power socket 602, an electronic device 606, a control device 608, and electronic device 634 integrated with socket device 636. Power socket 602 may be an example of power socket 102 or any of power sockets 502A-502F, as described above in reference to FIGS. 1 and 5, respectively. Electronic device 606 may be an example of electronic device 106, electronic device 306 or any of electronic devices 506A-506F, as described above in reference to FIGS. 1, 3 and 5, respectively.

Electronic device 634 is configured to be coupled to (i.e., plugged into) power socket 602 to receive power therefrom. Socket device 636 is configured to be coupled to electronic device 606. For example, socket device 636 comprises receptacle(s) that are each adapted to receive a prong of an electrical plug of a power cord of electronic device 606 (i.e., the electrical plug of the power cord of electronic device 606 is configured to be plugged into socket device 636). When the electrical plug of the power cord of electronic device 606 is attached to (i.e., plugged into) socket device 636, socket device 636 is configured to provide power (received from power socket 602) to electronic device 606. Thus, the electrical plug of the power cord of electronic device 606 is not plugged directly into power socket 602 to receive power therefrom, but instead, is plugged into socket device 636 of electronic device 634 thereby facilitating an indirect connection to power socket 602. Socket device 636 may be configured to measure an amount of current provided to electronic device 606 in a similar manner as described above with reference FIG. 3. Electronic device 634 (or socket device 636 of electronic device 634) may provide an indication of the measured amount of current to control device 608 via a wired or wireless connection in a similar manner as described above with reference to FIG. 3.

Control device 608 may be an example of control device 108, control device 308 or control device 508, as described above in reference to FIGS. 1, 3 and 5, respectively. Accordingly, control device 608 may be configured to receive the indication of the measured amount of current determined by socket device 636 and determine a power state of electronic device 606 in a similar manner as described above with reference to FIGS. 3 and 4.

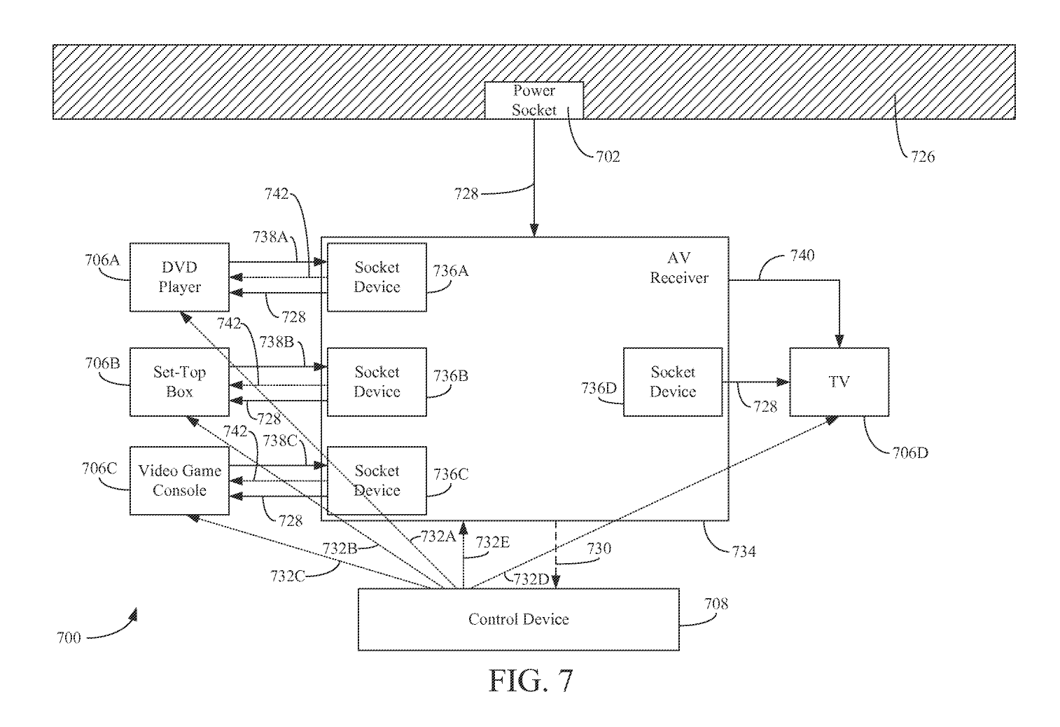

Control device 608 may be configured to perform an automated control scheme based on the determined power state. For example, FIG. 7 is a block diagram of a system 700 that is configured to determine a power state of one or more electronic devices 706A-706D and perform an automated control scheme based on the determined power state(s), in accordance with an embodiment. System 700 is configured to determine a power state of any or all of electronic device(s) 706A-706D based on the determined power state(s) in accordance with an embodiment. As shown in FIG. 7, system 700 includes a power socket 702, electronic devices 706A-706D, an electronic device 734 and a control device 708.

Power socket 702 may be an example of power socket 102, power sockets 502A-502F, or power socket 602, as described above in reference to FIGS. 1, 5 and 6, respectively. Power socket 702 is fixed and/or integrated into a wall 726 of a building structure. Power socket 702 is configured to provide power 728 to electronic device 734 when an electrical plug of a power cord of first electronic device 734 is coupled to (i.e., plugged into) power socket 702.

Electronic device 734 is integrated with socket devices 736A-736D. Each of socket devices 736A-736D comprise receptacle(s) that are adapted to receive corresponding prong(s) of an electrical plug of a power cord of an electronic device (e.g., electronic devices 706A-706D), thereby coupling the electronic device to a particular socket device. For example, electronic device 706A is coupled to (i.e., plugged into) socket device 736A, electronic device 706B is coupled to socket device 736B, electronic device 706C is coupled to socket device 736C and electronic device 706D is coupled to socket device 736D.

Electronic devices 706A-706D may be an example of electronic device 106, electronic device 306, electronic devices 506A-506F or electronic device 606, as described above in reference to FIGS. 1, 3, 5 and 6, respectively. As shown in FIG. 7, electronic device 706A is a DVD player, electronic device 706B is a set-top box, electronic device 706C is a video game console, electronic device 706D is a television and electronic device 734 is an AV receiver. AV receiver 734 is configured to select (e.g., switch between) different audio and/or video sources (i.e., DVD player 706A, set-top box 706B or video game console 706C) and provide an output signal 740 comprising audio and/or video signals (e.g., audio and/or video signals 738A, audio and/or video signals 738B or audio and/or video signals 738C) provided by the selected audio/video source. Output signal 740 is provided to TV 706D (and/or any other device capable of playing back audio and/or video signals (e.g., speakers)) for playback. The depiction of these particular electronic devices is merely for illustrative purposes. Each of electronic devices 706A-706D and electronic device 734 may be any electronic device that is capable of receiving AC power via a power socket.

Each of socket devices 736A-736D may be an example of socket device 636 as described above in reference to FIG. 6. Socket device 736A provides power 728 (received from power socket 702) to electronic device 706A. Socket device 736B provides power 728 (received from power socket 702) to electronic device 706B. Socket device 736C provides power 728 (received from power socket 702) to electronic device 706C. Socket device 736D provides power 728 (received from power socket 702) to electronic device 706D.

Socket device 736A is further configured to measure an amount of current provided to electronic device 706A. Socket device 736B is configured to measure an amount of current provided to electronic device 706B. Socket device 736C is configured to measure an amount of current provided to 706C. Socket device 736D is configured to measure an amount of current provided to electronic device 706D.

Electronic device 734 is configured to provide one or more indications 730 that each indicate the amount of measured current provided to a particular one of electronic devices 706A-706D to control device 708. In accordance with an embodiment, any of indication(s) 730 may be transmitted via a wired connection (e.g., via a USB cable, a coaxial cable, etc.). In accordance with another embodiment, any of indication(s) 730 may be transmitted via wireless connection (e.g., via IR communication, RF communication, etc.).

It is contemplated that each of socket devices 736A-736D may include a sensing component (e.g., sensing component 316, as shown in FIG. 3), processing component (e.g., processing component 318, as shown in FIG. 3) and/or a transmit component (e.g., transmit component 320, as shown in FIG. 3). It is further contemplated that a single processing component and/or transmit component is provided in electronic device 734 to service each of socket devices 736A-736D as would become apparent to a person of skill in the relevant art(s) having the benefit of this disclosure.

Control device 708 may be an example of control device 608, as described above in reference to FIG. 6. Control device 708 may be configured to determine that any or all of electronic device 706A-706D are to be in a desired power state and cause such electronic devices to transition to that desired power state based on a triggering event as described above in reference to FIG. 5. To determine whether or not an electronic device is already in a desired power state, control device 708 may determine the power state of that electronic device based on an indication (e.g., indication(s) 730) of the amount of current provided to that electronic device from its associated socket device, as described above in reference to FIGS. 3 and 5. If the determined power state for a particular electronic device is the desired power state, no further action is required by control device 708 with respect to altering the power state of the particular electronic device. However, if the determined power state for a particular electronic device is not the desired power state, control device 708 causes the particular electronic device to transition to the desired power state. For example, control device 708 may transmit a control signal 732A to electronic device 706A that causes electronic device 706A to transition to a desired power state. Control device 708 may transmit a control signal 732B to electronic device 706B that causes electronic device 706B to transition to a desired power state. Control device 708 may transmit a control signal 732C to electronic device 706C that causes electronic device 706C to transition to a desired power state. Control device 708 may transmit a control signal 732D to electronic device 706D that causes electronic device 706D to transition to a desired power state.

In an embodiment, in the event that a particular electronic device is to be powered on, control device 708 may transmit a control signal 732E to electronic device 734, which causes electronic device 734 to automatically select (i.e., switch to) that particular electronic device for providing audio and/or video for playback. For example, if control device 708 determines that video game console 706 is to be powered on, control signal 732E may cause AV receiver 734 to select video game console 706 for providing audio and/or video signals 738C for playback on TV 706D.

In accordance with another embodiment, instead of providing control signal(s) 732A-732D directly to electronic device(s) 706A-706D to cause a transition of a power state thereof, control device 708 may send a control signal 732E to electronic device 734, and, in response, electronic device 734 may provide a control signal 742 that causes the transition of the power state to electronic device(s) 706A-706D.

In accordance with an embodiment, any of control signals 732A-732E may be transmitted via a wired connection (e.g., via a USB cable, a coaxial cable, etc.). In accordance with another embodiment, any of control signals 732A-732E may be transmitted via wireless connection (e.g., via IR communication, RF communication, etc.).

It is noted that control device 708 may be implemented as a stand-alone device (as shown in FIG. 7), such as a set-top box, a laptop, a tablet, a telephone (e.g., a smart phone and/or a mobile phone, or a switching device or a remote control device (as disclosed in U.S. patent application Ser. No. ______ (Atty. Docket No. H16.00010001), entitled, “Seamless Setup and Control for Home Entertainment Devices and Content,” the entirety of which is incorporated by reference herein), or may be integrated into electronic device 734.
c. Method for Performing an Automated Control Function for an Electronic Device

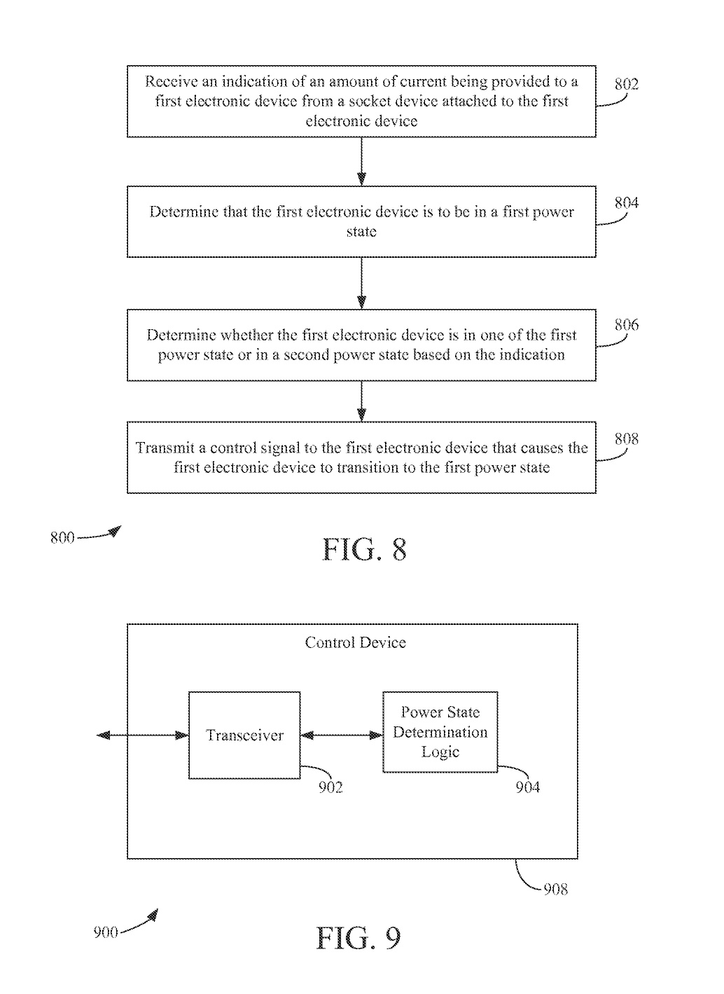

Accordingly, in embodiments, a control device may be configured to perform an automated control function for one or more electronic devices in many ways. For instance, FIG. 8 depicts a flowchart 800 of a method for performing an automated control function by a control device in accordance with an embodiment. The method of flowchart 800 may be implemented by control device 908 shown in FIG. 9. FIG. 9 is a block diagram of control device 908 in accordance with an embodiment. Control device 908 may be an example of control device 108, control device 308, control device 508, control device 608 or control device 708, as described above in reference to FIGS. 1, 3, 5, 6 and 7, respectively. As shown in FIG. 9, control device 908 includes a transceiver 902 and power state determination logic 904. Other structural and operational embodiments will be apparent to persons skilled in the relevant art(s) based on the following discussion regarding flowchart 800 and control device 908.

Flowchart 800 begins with step 802. At step 802, an indication of an amount of current being provided to a first electronic device from a socket device attached to the first electronic device is received. For example, with reference to FIG. 9, transceiver 902 may receive the indication from a socket device (e.g., socket device 104, socket device 204, socket device 304, socket device 504, socket device 604 or socket device 704, as described above in reference to FIGS. 1-3 and 5-7, respectively) attached to the first electronic device (e.g., electronic device 106, electronic device 306, electronic device 506, electronic device 606 or electronic device 706, as described above in reference to FIGS. 1, 3 and 5-7, respectively). In accordance with an embodiment, the indication is provided to transceiver 902 via a wired connection (e.g., via a USB cable, a coaxial cable, etc.). In accordance with another embodiment, the indication is provided to transceiver 902 via a wireless connection (e.g., via IR communication, RF communication, etc.). In accordance with such an embodiment, transceiver 902 comprises an antenna for wirelessly receiving and/or transmitting data (e.g., the indication).

At step 804, it is determined that the first electronic device is to be in a first power state. For example, with reference to FIG. 9, power state determination logic 904 may determine that the first electronic device is to be in a first power state.

In accordance with an embodiment, it may be determined that the first electronic device is to be in a first power state by detecting a triggering event. The triggering event may be indicative of a user performing an action intended to cause the first electronic device to transition to the first power state. The action may comprise the user interacting with an interface element of a remote control device that, when activated, is intended to cause the first electronic device to be in the first power state.

In accordance with another embodiment, it may be determined that the first electronic device is to be in a first power state by detecting a triggering event that indicates that another electronic device has transitioned to a particular power state. For example, with reference to FIG. 9, transceiver 902 may receive a second indication of an amount of current being provided to the second electronic device from a socket device attached to the second electronic device. Thereafter, it may be determined that the second electronic device has undergone the transition in power state based on the indication. For example, with reference to FIG. 9, power state determination logic 904 may determine that the second electronic device has undergone the transition in power state based on the indication.

At step 806, it is determined whether the first electronic device is in one of the first power state or in a second power state based on the indication of the amount of current being provided to the first electronic device received from the socket device attached to the first electronic device. For example, with reference to FIG. 9, power state determination logic 904 determines whether the first electronic device is in one of the first power state or in the second power state based on this indication. For instance, power state determination logic 904 may compare the indicated amount of current being provided to the first electronic device to one or more thresholds (as described above with reference to FIG. 4) to determine whether the first electronic device is in one of the first power state or in the second power state.

At step 808, in response to determining that the first electronic device is in the second power state, a control signal is transmitted to the first electronic device that causes the first electronic device to transition to the first power state. For example, with reference to FIG. 9, transceiver 902 may transmit a control signal to the first electronic device that causes the first electronic device to transition to the first power state. In accordance with an embodiment, the control signal is provided to transceiver 902 via a wired connection (e.g., via a USB cable, a coaxial cable, etc.). In accordance with another embodiment, the control signal is provided to transceiver 902 via a wireless connection (e.g., via IR communication, RF communication, etc.).

In accordance with an embodiment, control device 908 uses a separate transmitter and receiver (rather than transceiver 902) for performing communication with a socket device and/or an electronic device. In accordance with such an embodiment, each of the transmitter and receiver may be configured to communicate with a socket device and/or an electronic device in accordance with different communication technologies.

In accordance with an embodiment, the first power state is a power-on state, and the second power state is at least one of a low-power state or a power-off state. In accordance with another embodiment, the first power state is at least one of a low-power state or a power-off state, and the second power state is a power-on state.

In some example embodiments, one or more of operations 802, 804, 806 and/or 808 of flowchart 800 may not be performed. Moreover, operations in addition to or in lieu of operations 802, 804, 806 and/or 808 may be performed. Further, in some example embodiments, one or more of operations 802, 804, 806 and/or 808 may be performed out of order, in an alternate sequence, or partially (or completely) concurrently with each other or with other operations.
B. Systems and Methods for Determining a Power State of an Electronic Device Based on an Amount of Power Being Provided to a Socket Device by the Electronic Device and Performing an Automated Control Scheme Based the Determined Power State
   a. A Socket Device Configured to Determine an Amount of Power Provided by an Electronic Device Coupled Thereto

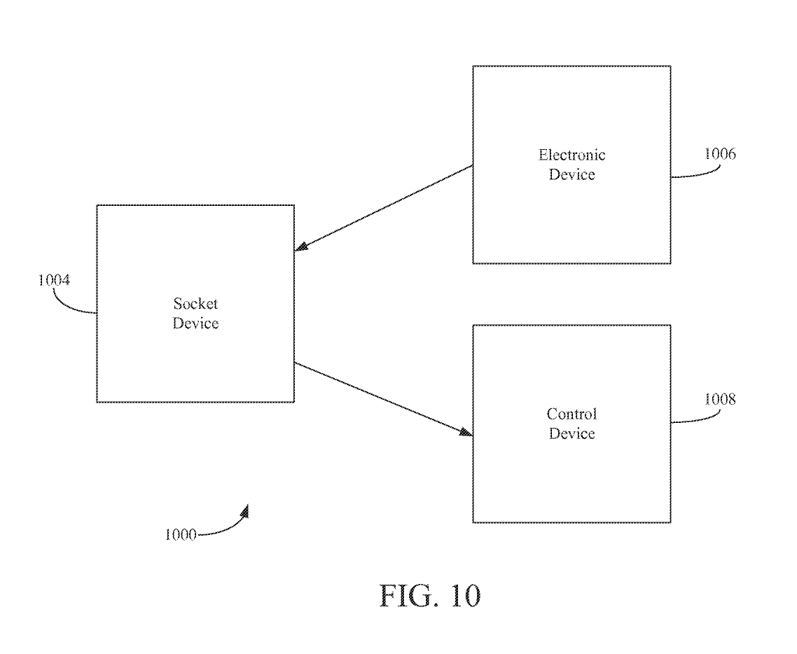

FIG. 10 is a block diagram of a system 1000 that is configured to determine a power state of an electronic device 1006 and perform an automated control scheme based on the determined power state in accordance with another embodiment. As shown in FIG. 10, system 1000 includes a socket device 1004, electronic device 1006 and a control device 1008. Electronic device 1006 may be an example of electronic device 106, electronic device 306, any of electronic devices 506A-506F, electronic device 606, electronic device 634, or any of electronic devices 738A-738D, as described above in reference to FIGS. 1, 3, 5, 6 and 7, respectively. Electronic device 1006 may be plugged into a power socket (not shown) to receive power therefrom.

Socket device 1004 is configured to be coupled to electronic device 1006. For example, socket device 1004 may be plugged into a port or connector of electronic device 1006. In accordance with an embodiment, socket device 1004 is a Universal Serial Bus (USB) device (e.g., a dongle) that is plugged into a USB port of electronic device 1006.

Electronic device 1006 is configured to provide an amount of power to socket device 1004 based on the power state of electronic device 1006. Socket device 1004 is configured to measure the amount of power received from electronic device 1006. In accordance with an embodiment, upon measuring the amount of power, socket device 1004 may be configured to determine the power state of electronic device 1006 based on the measured amount of power and transmit an indication of the determined power state to control device 1008. The amount of power provided to socket device 1004 may vary depending on the type of port or connector to which socket device 1004 is coupled. For example, in accordance with a USB protocol, the amount of power provided to socket device 1004 when electronic device 1006 is in a power-on state corresponds to an output voltage of five volts. When electronic device 1006 is in a power-off state or a standby state, the amount of power provided to the socket device 1004 corresponds to an output voltage of zero. Accordingly, socket device 1004 may determine that electronic device 1006 is in a power-on state by comparing the output voltage to a threshold. If the output voltage provided to socket device 1004 reaches the threshold (e.g., approximately five volts), socket device 1004 may determine that electronic device 1006 is in a power-on state. If the output voltage is less than the threshold (e.g., approximately zero volts), socket device 1004 may determine that electronic device 1006 is in a standby state or a power-off state.

It should be noted that socket device 1004 could use other techniques to determine the power state of electronic device 1006. For example, control device 1006 may be configured to determine whether the measured amount of power is equal to (or within a predefined range of) the threshold to determine the power state of electronic device 1006.

Socket device 1004 may also include an internal power source (e.g., a battery) or may be coupled to an external power source (e.g., a power socket) that provides power to socket device 1004 when electronic device 1006 is de-activated. This advantageously enables socket device 1004 to transmit the indication when not receiving power from electronic device 1006.

Control device 1008 may be an example of control device 108, control device 308, control device 508, control device 608, control device 708 or control device 908, as described above in reference to FIGS. 1, 3, 5-7 and 9, respectively. Control device 1008 may be configured to determine that electronic device 1006 is to be in a desired power state and cause electronic device 1006 to transition to that desired power state based on a triggering event as described above in reference to FIG. 5. To determine whether or not an electronic device is already in a desired power state, control device 1008 may determine the power state of that electronic device based on the indication of the amount of power provided to electronic device 106 from socket device 1004. If the determined power state for a particular electronic device is the desired power state, no further action is required by control device 1008 with respect to altering the power state of the particular electronic device. However, if the determined power state for a particular electronic device is not the desired power state, control device 1008 causes the particular electronic device to transition to the desired power state. For example, control device 1008 may provide a control signal to electronic device 1006 that causes electronic device 1006 to transition to the desired state. In accordance with an embodiment, the indication may be received and/or the control signal may be transmitted via a wired connection between socket device 1004 and control device 1008 (e.g., via a USB cable, a coaxial cable, etc.). In accordance with another embodiment, the indication may be received and/or the control signal may be transmitted via a wireless connection between socket device 1004 and control device 1008 (e.g., via IR communication, RF communication, etc.).

It is noted that instead of socket device 1004 transmitting the determined power state of electronic device 1006, socket device 1004 may transmit an indication of the measured amount of power to control device 1008, and control device 1008 may determine the power state of electronic device 1006 based on the indication.

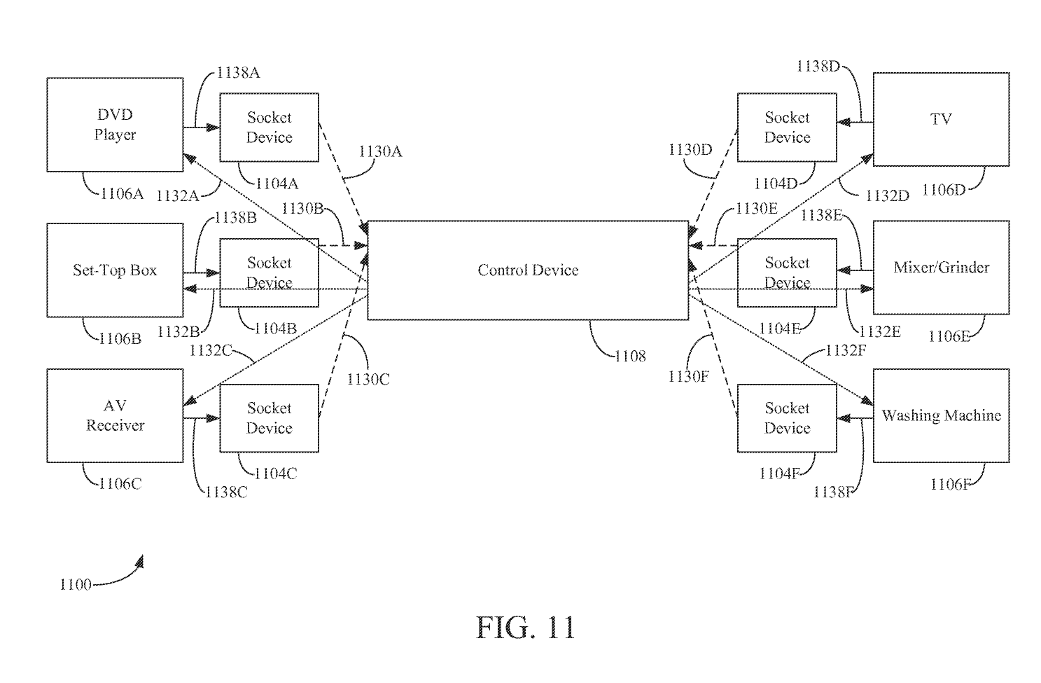

FIG. 11 is a block diagram of a system 1100 that is configured to determine a power state of electronic device(s) 1106A-1106F and perform an automated control scheme based on the determined power state(s) in accordance with another embodiment. As shown in FIG. 11 system 1100 includes socket devices 1104A-1104F, electronic devices 1106A-1106F and a control device 1108. Socket devices 1104A-1104F may be an example of socket device 1004, as described above in reference to FIG. 10. Electronic devices 1106A-1106F may be examples of electronic device 1006, as described above in reference to FIG. 10. Control device 1108 may be an example of control device 1008, as described above in reference to FIG. 10.

As further shown in FIG. 11, electronic device 1106A is a DVD player, electronic device 1106B is a set-top box, electronic device 1106C is an AV receiver, electronic device 1106D is a TV, electronic device 1106E is a mixer and/or grinder, and electronic device 1106F is a washing machine. The depiction of these particular electronics devices/home appliances is merely for illustrative purposes. Each of electronic devices 1106A-1106F may be any electronic device or home appliance that is capable of receiving AC power via a power socket and/or providing power to a socket device coupled thereto via a port or connector.

Electronic device 1106A provides power 1138A to socket device 1104A. Electronic device 1106B provides power 1138B to socket device 1104A. Electronic device 1106B provides power 1138B to socket device 1104B. Electronic device 1106C provides power 1138 to socket device 1104C. Electronic device 1106D provides power 1138D to socket device 1104D. Electronic device 1106E provides power 1138E to socket device 1104E. Electronic device 1106F provides power 1138F to socket device 1104F.

Socket device 1104A is configured to measure the amount of power received from electronic device 1106A, determine the power state of electronic device 1106A and/or provide an indication 1130A that indicates the determined power state of electronic device 1106A to control device 1108. Socket device 1104B is configured to measure the amount of power received from electronic device 1106B, determine the power state of electronic device 1106B, and/or provide an indication 1130B that indicates the determined power state of electronic device 1106B to control device 1108. Socket device 1104C is configured to measure the amount of power received from electronic device 1106C, determine the power state of electronic device 1106C and/or provide an indication 1130C that indicates the determined power state of electronic device 1106C to control device 1108. Socket device 1104D is configured to measure the amount of power received from electronic device 1106D, determine the power state of electronic device 1106D and/or provide an indication 1130D that indicates the determined power state of electronic device 1106D to control device 1108. Socket device 1104E is configured to measure the amount of power received from electronic device 1106E, determine the power state of electronic device 1106E and/or provide an indication 1130E that indicates the determined power state of electronic device 1106E to control device 1108. Socket device 1104F is configured to measure the amount of power received from electronic device 1106F, determine the power state of electronic device 1106F and/or provide an indication 1130F that indicates the determined power state of electronic device 1106F to control device 1108.

In accordance with an embodiment, each of socket devices 1104A-1104F are configured to provide a respective indication of the power state of the electronic device coupled thereto via a wired connection (e.g., via a USB cable, a coaxial cable, etc.). In accordance with another embodiment, each of socket devices 1106A-1106F are configured to provide a respective indication of the power state of the electronic device coupled thereto via a wireless connection (e.g., via IR communication, RF communication, etc.).

Control device 1108 may be configured to determine that any or all of electronic device 1106A-1106D are to be in a desired power state and cause such electronic devices to transition to that desired power state based on a triggering point as described above in reference to FIG. 5. To determine whether or not an electronic device is already in a desired power state, control device 1108 may determine the power state of that electronic device based on the indication received for that electronic device (e.g., indication(s) 1130A-1130F). If the determined power state for a particular electronic device is the desired power state, no further action is required by control device 1108 with respect to altering the power state of the particular electronic device. However, if the determined power state for a particular electronic device is not the desired power state, control device 1108 causes the particular electronic device to transition to the desired power state. For example, control device 1108 may transmit a control signal 1132A to electronic device 1106A that causes electronic device 1106A to transition to a desired power state. Control device 1108 may transmit a control signal 1132B to electronic device 1106B that causes electronic device control 1106B to transition to a desired power state. Control device 1108 may transmit a control signal 1132C to electronic device 1106C that causes electronic device 1106C to transition to a desired power state. Control device 1108 may transmit a control signal 1132D to electronic device 1106D that causes electronic device 1106D to transition to a desired power state. Control device 1108 may transmit a control signal 1132E to electronic device 1106E that causes electronic device 1106E to transition to a desired power state. Control device 1108 may transmit a signal 1132F to electronic device 1106F that causes electronic device 1106F to transition to a desired power state.

In accordance with an embodiment, any of control signals 1132A-1132F may be transmitted via a wired connection (e.g., via a USB cable, a coaxial cable, etc.). In accordance with another embodiment, any of control signals 1132A-1132F may be transmitted via wireless connection (e.g., via IR communication, RF communication, etc.).

It is noted that while the embodiments above describe that socket devices 1104A-1104F determine the power state of the respective electronic device coupled thereto, in accordance with certain embodiments, each of socket devices 1104A-1104F may be configured to provide an indication of the amount of power measured by the socket device to control device 1108, and control device 1108 may determine the power state of that electronic device based on the indication.
b. Method for Determining a Power State of an Electronic Device Based on an Amount of Power Provided to a Socket Device Coupled Thereto.

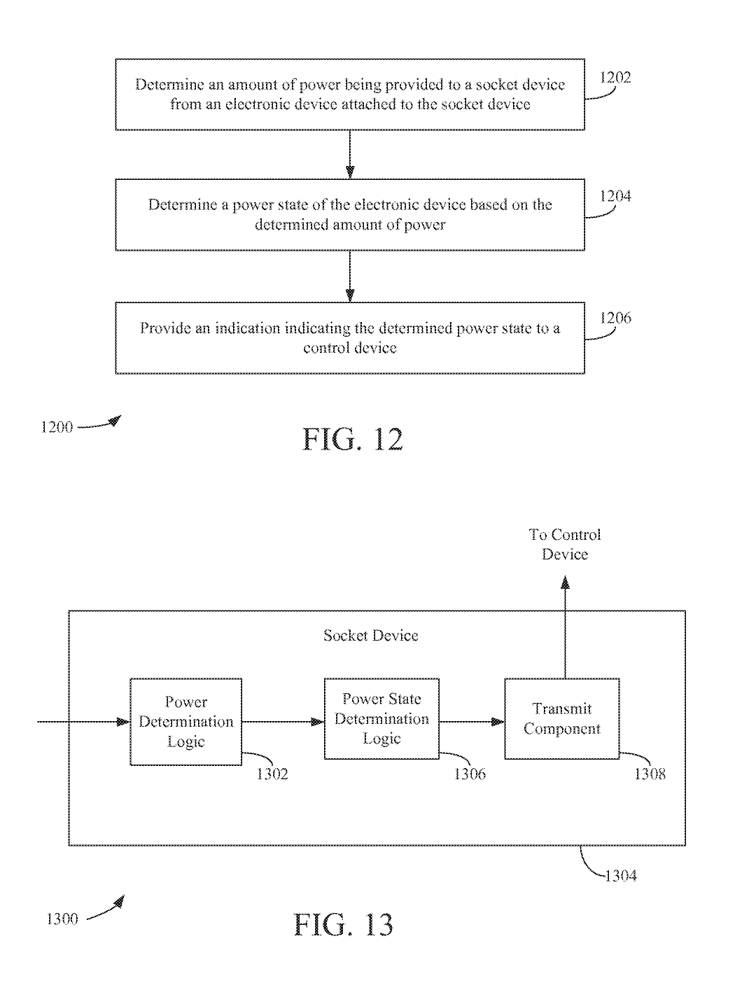

Accordingly, in embodiments, a socket device may be configured to determine the power state of an electronic device coupled thereto in many ways. For instance, FIG. 12 depicts a flowchart 1200 of a method for determining a power state of an electronic device in accordance with an embodiment. The method of flowchart 1200 may be implemented by socket device 1304 shown in FIG. 13. FIG. 13 is a block diagram of socket device 1304 in accordance with an embodiment. Socket device 1304 may be an example of socket device 1004 or socket device 1104, as described above in reference to FIGS. 10 and 11, respectively. As shown in FIG. 13, socket device 1304 includes power determination logic 1302, power state determination logic 1306 and a transmit component 1308. Other structural and operational embodiments will be apparent to persons skilled in the relevant art(s) based on the following discussion regarding flowchart 1200 and socket device 1304.

Flowchart 1200 begins with step 1202. At step 1202, an amount of power being provided to a socket device from an electronic device attached to the socket device is determined For example, with reference to FIG. 13, power determination logic 1302 may determine the amount of power being provided to socket device 1304 from an electronic device (e.g., electronic device 1006 or electronic devices 1106A-1106F, as described above in reference to FIGS. 10 and 11, respectively). For instance, power determination logic 1302 may be coupled to a power control line on which the electronic device provides power to socket device 1304. In accordance with an embodiment, socket device 1304 is a USB dongle plugged into a USB port or connector of the first electronic device.

At step 1204, a power state of the electronic device is determined based on the determined amount of power. For example, with reference to FIG. 13, power state determination logic 1306 may determine the power state of the electronic device based on the determined amount of power. For instance, power state determination logic 1306 may compare the determined amount of power to a threshold. If the determined amount of power reaches the threshold, then power state determination logic 1306 may determine that the electronic device is in a first power state. If the determined amount of power does not reach the threshold, then power state determination logic 1306 may determine that the electronic device in a second power state.

At step 1206, an indication indicating the determined power state is provided to a control device. For example, as shown in FIG. 13, transmit component 1308 may provide the indication to the control device (e.g., control device 1008 or control device 1108, as respectively shown in FIGS. 10 and 11). In accordance with an embodiment, transmit component 1308 provides the indication via a wired connection between socket device 1304 and the control device (e.g., via a USB cable, a coaxial cable, etc.). In accordance with another embodiment, transmit component 1308 provides the indication via a wireless connection between socket device 1304 and the control device (e.g., via IR communication, RF communication, etc.).

In some example embodiments, one or more of operations 1202, 1204 and/or 1206 of flowchart 1200 may not be performed. Moreover, operations in addition to or in lieu of operations 1202, 1204 and/or 1206 may be performed. Further, in some example embodiments, one or more of operations 1202, 1204 and/or 1206 may be performed out of order, in an alternate sequence, or partially (or completely) concurrently with each other or with other operations.

### Further Example Embodiments

A device, as defined herein, is a machine or manufacture as defined by 35 U.S.C. §101. Devices may be digital, analog or a combination thereof. Devices may include integrated circuits (ICs), one or more processors (e.g., central processing units (CPUs), microprocessors, digital signal processors (DSPs), etc.) and/or may be implemented with any semiconductor technology, including one or more of a Bipolar Junction Transistor (BJT), a heterojunction bipolar transistor (HBT), a metal oxide field effect transistor (MOSFET) device, a metal semiconductor field effect transistor (MESFET) or other transconductor or transistor technology device. Such devices may use the same or alternative configurations other than the configuration illustrated in embodiments presented herein.

Techniques and embodiments, including methods, described herein may be implemented in hardware (digital and/or analog) or a combination of hardware and software and/or firmware. Techniques described herein may be implemented in one or more components. Embodiments may comprise computer program products comprising logic (e.g., in the form of program code or instructions as well as firmware) stored on any computer useable storage medium, which may be integrated in or separate from other components. Such program code, when executed in one or more processors, causes a device to operate as described herein. Devices in which embodiments may be implemented may include storage, such as storage drives, memory devices, and further types of computer-readable media. Examples of such computer-readable storage media include, but are not limited to, a hard disk, a removable magnetic disk, a removable optical disk, flash memory cards, digital video disks, random access memories (RAMs), read only memories (ROM), and the like. In greater detail, examples of such computer-readable storage media include, but are not limited to, a hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may, for example, store computer program logic, e.g., program modules, comprising computer executable instructions that, when executed, provide and/or maintain one or more aspects of functionality described herein with reference to the figures, as well as any and all components, steps and functions therein and/or further embodiments described herein.

Computer readable storage media are distinguished from and non-overlapping with communication media. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wired media as well as wireless media such as acoustic, RF, infrared and other wireless media. Example embodiments are also directed to such communication media.

The automatic detection of the power status of electronic device(s) and/or the automatic control scheme of electronic device(s) embodiments and/or any further systems, sub-systems, and/or components disclosed herein may be implemented in hardware (e.g., hardware logic/electrical circuitry), or any combination of hardware with software (computer program code configured to be executed in one or more processors or processing devices) and/or firmware.

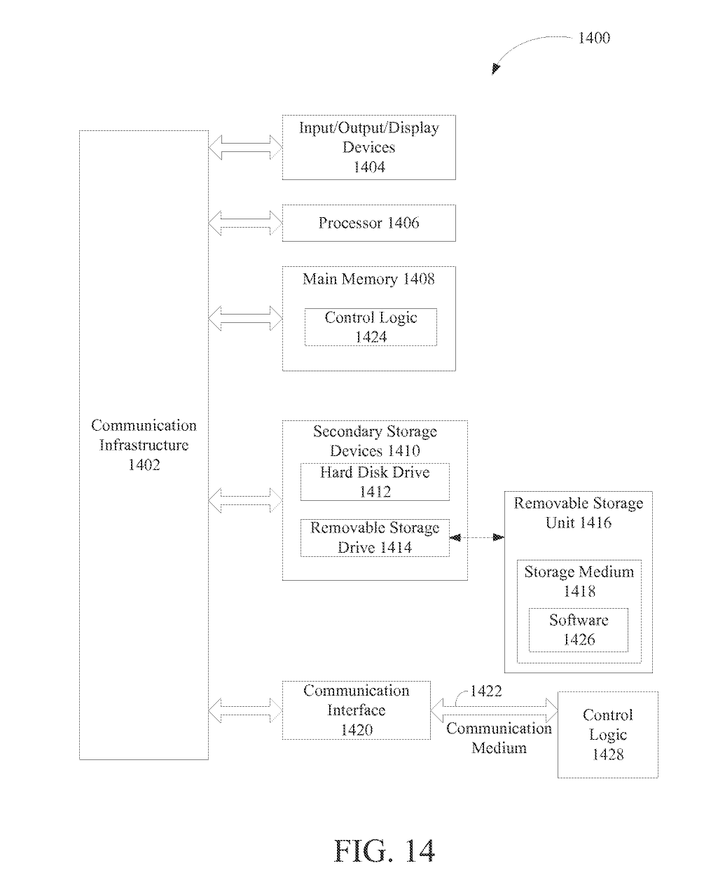

The embodiments described herein, including systems, methods/processes, and/or apparatuses, may be implemented using well known processing devices, telephones (smart phones and/or mobile phones), servers, electronic devices (e.g., consumer electronic devices) and/or, computers, such as a computer 1400 shown in FIG. 14. It should be noted that computer 1400 may represent communication devices, processing devices, servers, and/or traditional computers in one or more embodiments. For example, socket device 104, socket device 204, socket device 304, socket device 504, socket device 604, socket device 704, socket device 1004, socket devices 1104A-1104F and/or socket device 1304 (as described above in reference to FIGS. 1-3, 5-7, 10, 11 and 13, respectively), control device 108, control device 308, control device 508, control device 608, control device 708, control device 908, control device 1008 and/or control device 1108 (as described above in reference to FIGS. 1, 3, 5-7 and 9-11, respectively), electronic device 106, electronic device 306, electronic device 506A-506F, electronic device 606, electronic device 706A-706D, electronic device 734, electronic device 1006, and/or electronic devices 1106A-1106F (as described above in reference to FIGS. 1, 3, 5-8, 10 and 11, respectively), any of the sub-systems, components or sub-components respectively contained therein, may be implemented using one or more computers 1400.

Computer 1400 can be any commercially available and well known communication device, processing device, and/or computer capable of performing the functions described herein, such as devices/computers available from International Business Machines®, Apple®, Sun®, HP®, Dell®, Cray®, Samsung®, Nokia®, etc. Computer 1400 may be any type of computer, including a desktop computer, a server, etc.

Computer 1400 includes one or more processors (also called central processing units, or CPUs), such as a processor 1406. Processor 1406 is connected to a communication infrastructure 1402, such as a communication bus. In some embodiments, processor 1406 can simultaneously operate multiple computing threads.

Computer 1400 also includes a primary or main memory 1408, such as random access memory (RAM). Main memory 1408 has stored therein control logic 1424 (computer software), and data.

Computer 1400 also includes one or more secondary storage devices 1410. Secondary storage devices 1410 include, for example, a hard disk drive 1412 and/or a removable storage device or drive 1414, as well as other types of storage devices, such as memory cards and memory sticks. For instance, computer 1400 may include an industry standard interface, such a universal serial bus (USB) interface for interfacing with devices such as a memory stick. Removable storage drive 1414 represents a floppy disk drive, a magnetic tape drive, a compact disk drive, an optical storage device, tape backup, etc.

Removable storage drive 1414 interacts with a removable storage unit 1416. Removable storage unit 1416 includes a computer useable or readable storage medium 1418 having stored therein computer software 1426 (control logic) and/or data. Removable storage unit 1416 represents a floppy disk, magnetic tape, compact disk, DVD, optical storage disk, or any other computer data storage device. Removable storage drive 1414 reads from and/or writes to removable storage unit 1416 in a well-known manner.

Computer 1400 also includes input/output/display devices 1404, such as touchscreens, LED and LCD displays, monitors, keyboards, pointing devices, etc.

Computer 1400 further includes a communication or network interface 1418. Communication interface 1420 enables computer 1400 to communicate with remote devices. For example, communication interface 1420 allows computer 1400 to communicate over communication networks or mediums 1422 (representing a form of a computer useable or readable medium), such as LANs, WANs, the Internet, etc. Network interface 1420 may interface with remote sites or networks via wired or wireless connections.

Control logic 1428 may be transmitted to and from computer 1400 via the communication medium 1422.

Any apparatus or manufacture comprising a computer useable or readable medium having control logic (software) stored therein is referred to herein as a computer program product or program storage device. This includes, but is not limited to, computer 1400, main memory 1408, secondary storage devices 1410, and removable storage unit 1416. Such computer program products, having control logic stored therein that, when executed by one or more data processing devices, cause such data processing devices to operate as described herein, represent embodiments of the invention.

Any apparatus or manufacture comprising a computer useable or readable medium having control logic (software) stored therein is referred to herein as a computer program product or program storage device. This includes, but is not limited to, a computer, computer main memory, secondary storage devices, and removable storage units. Such computer program products, having control logic stored therein that, when executed by one or more data processing devices, cause such data processing devices to operate as described herein, represent embodiments of the inventive techniques described herein.

### CONCLUSION

While various embodiments have been described above, it should be understood that they have been presented by way of example only, and not limitation. It will be apparent to persons skilled in the relevant art(s) that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A socket device, comprising:
a first receptacle configured to receive a first prong of an electrical plug and couple the first prong to a first conductive element of the socket device;
a second receptacle configured to receive a second prong of the electrical plug and couple the second prong to a second conductive element of the socket device;
a sensing component configured to determine an amount of current provided via at least one of the first conductive element and the second conductive element; and
a transmit component configured to transmit an indication of the amount of current to a control device.

2. The socket device of claim 1, further comprising:
a first prong configured to be inserted into a first receptacle of a power socket; and
a second prong configured to be inserted into a second receptacle of the power socket.

3. The socket device of claim 1, wherein the transmit component comprises an antenna configured to wirelessly provide the indication to the control device.

4. The socket device of claim 1, wherein the sensing component comprises:
a resistive element coupled to at least one of the first conductive element and the second conductive element,
wherein the sensing component is configured to determine an amount of voltage across at least one of the first conductive element and the second conductive element and determine the amount of current based on the determined voltage.

5. The socket device of claim 1, wherein the sensing component comprises at least one of:
a current transformer coupled to at least one of the first conductive element and the second conductive element and configured to measure the amount of current provided via at least one of the first conductive element and the second conductive element; and
a Hall effect current sensor coupled to at least one of the first conductive element and the second conductive element and configured to measure the amount of current provided via at least one of the first conductive element and the second conductive element.

6. The socket device of claim 1, wherein the socket device is integrated into an audio-video receiver.

7. A system, comprising:
a socket device configured to determine an amount of current being provided to a first electronic device attached thereto and transmit an indication of the amount of current; and
a control device configured to:
receive the indication of the amount of current from the socket device;
determine that the first electronic device is to be in a first power state;
determine whether the first electronic device is in one of the first power state or a second power state based on the indication; and
in response to a determination that the first electronic device is in the second power state, transmit a signal to the first electronic device that causes the first electronic device to transition to the first power state.

8. The system of claim 7, wherein the first power state is a power-on state, and wherein the second power state is at least one of a low-power state or a power-off state.

9. The system of claim 7, wherein the first power state is at least one of a low-power state or a power-off state, and wherein the second power state is a power-on state.

10. The system of claim 7, wherein the control device is configured to determine that the first electronic device is to be in the first power state by:
detecting a triggering event indicative of a user performing an action intended to cause the first electronic device to transition to the first power state.

11. The system of claim 10, wherein the action comprises the user interacting with an interface element of a remote control device that, when activated, is intended to cause the first electronic device to be in the first power state.

12. The system of claim 10, wherein the socket device is configured to transmit the indication of the amount of current and the control device is configured to receive the indication of the amount of current wirelessly.

13. A method for controlling a first electronic device, comprising:
receiving an indication of an amount of current being provided to the first electronic device from a socket device attached to the first electronic device;
determining that the first electronic device is to be in a first power state;
determining whether the first electronic device is in one of the first power state or a second power state based on the indication; and
in response to determining that the first electronic device is in the second power state, transmitting a control signal to the first electronic device that causes the first electronic device to transition to the first power state.

14. The method of claim 13, wherein the first power state is a power-on state, and wherein the second power state is at least one of a low-power state or a power-off state.

15. The method of claim 13, wherein the first power state is at least one of a low-power state or a power-off state, and wherein the second power state is a power-on state.

16. The method of claim 13, wherein determining that the first electronic device is to be in the first power state comprises:
detecting a triggering event indicative of a user performing an action intended to cause the first electronic device to transition to the first power state.

17. The method of claim 16, wherein the action comprises the user interacting with an interface element of a remote control device that, when activated, is intended to cause the first electronic device to be in the first power state.

18. The method of claim 13, wherein determining that the first electronic device is to be in the first power state comprises:
detecting a triggering event that indicates that another electronic device has transitioned to a particular power state.

19. The method of claim 13, wherein receiving the indication of the amount of current being provided to the first electronic device from the socket device attached to the first electronic device comprises:
wirelessly receiving the indication of the amount of current being provided to the first electronic device from the socket device attached to the first electronic device.

20. A socket device, comprising:
a sensing component configured to determine an amount of power being provided to the socket device from an electronic device attached to the socket device;
a processing component configured to determine a power state of the electronic device based on the determined amount of power; and
a transmit component configured to provide an indication indicating the determined power state to a control device.
